(19) United States
(12) Patent Application Publication
(10) Pub. No.: US 2025/0222817 A1
(43) Pub. Date: Jul. 10, 2025

(54) METHODS AND SYSTEM FOR SERVICING BATTERY

(71) Applicant: Ford Global Technologies, LLC, Dearborn, MI (US)

(72) Inventors: Stuart C. Salter, White Lake, MI (US); David Celinske, Wolverine Lake, MI (US); Todd Ansbacher, Westland, MI (US); John DeMarco, Lake Orion, MI (US); Mark Roseman, Southfield, MI (US)

(21) Appl. No.: 18/409,408

(22) Filed: Jan. 10, 2024

(51) Int. Cl. B60L 53/80

(52) U.S. Cl. CPC B60L 53/80; B60L 2210/10; B60L 2250/16

(57) ABSTRACT

Systems and methods for operating a vehicle power system are described. The vehicle power system includes a lower voltage battery and a power distribution system. The power distribution system may open and close one or more switches in response to a request to replace a battery so that the battery may be replaced with ease.

### FIELD

The present description relates to methods and a system for servicing a battery of a vehicle. The methods and systems may be particularly useful for electric vehicles.

### BACKGROUND AND SUMMARY

An electric vehicle may include a lower voltage battery and a higher voltage battery. The lower voltage battery may power electrical devices that do not propel a vehicle whereas the higher voltage battery may provide electric power to a traction motor. The higher voltage battery may or may not be in electrical communication with the lower voltage battery via a DC/DC converter and the higher voltage battery and the lower voltage battery may be constructed of different materials. The lower voltage battery may have a shorter life span than the higher voltage battery and it may be replaced more frequently than the higher voltage battery. The vehicle's human user or operator may wish to replace the lower voltage battery on their own, but they may not wish to read through an operator's manual.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle;

FIG. 2 is a view of an example infotainment system;

FIG. 3 is an example of view screen of an interactive battery service application;

FIG. 4 is a schematic view of an example electric power distribution system; and

FIGS. 5 and 6 show a flow chart of an example method of servicing a lower voltage battery of a vehicle.

### DETAILED DESCRIPTION

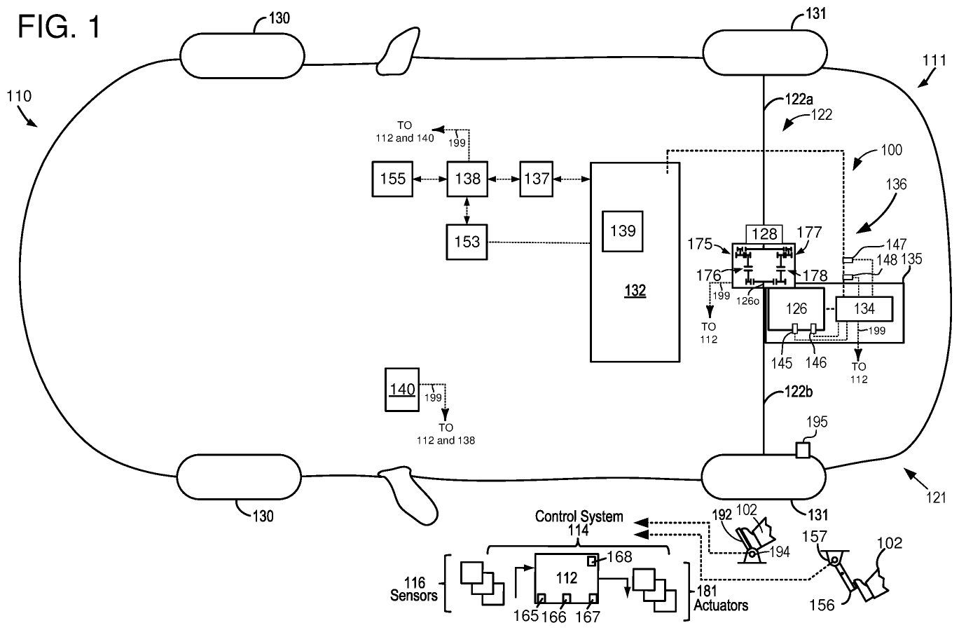

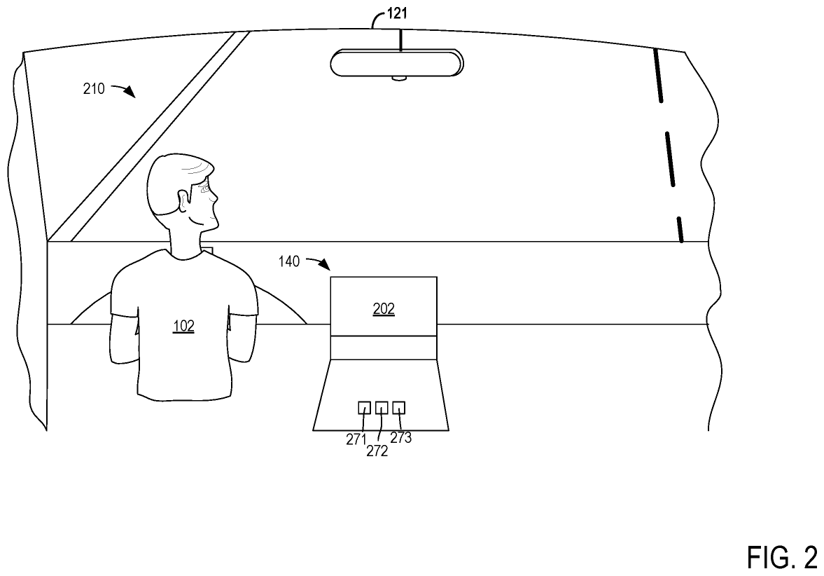

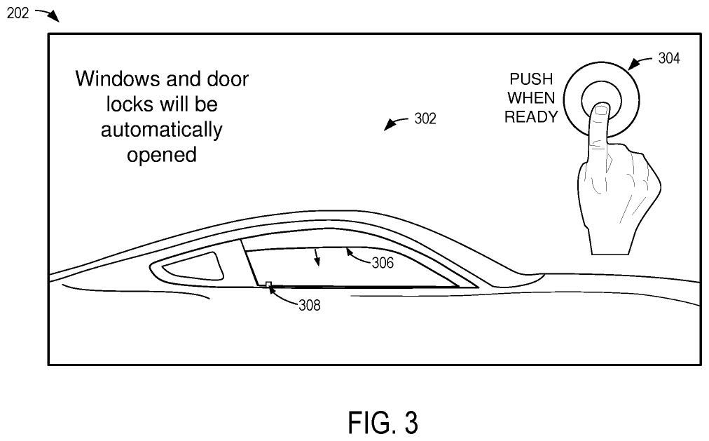

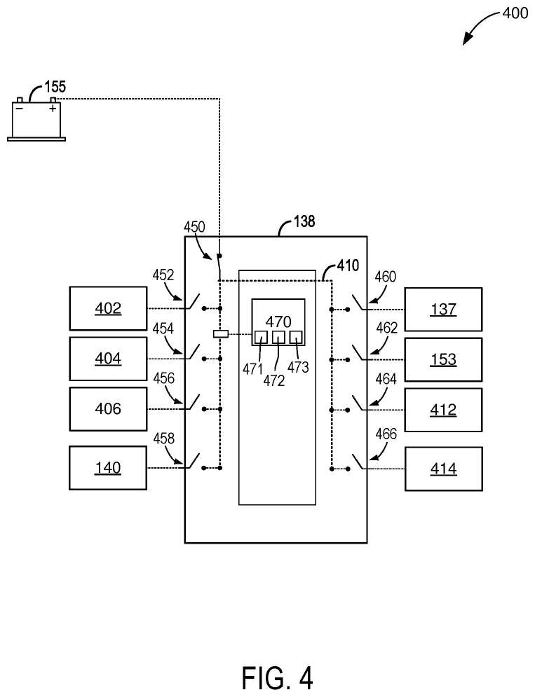

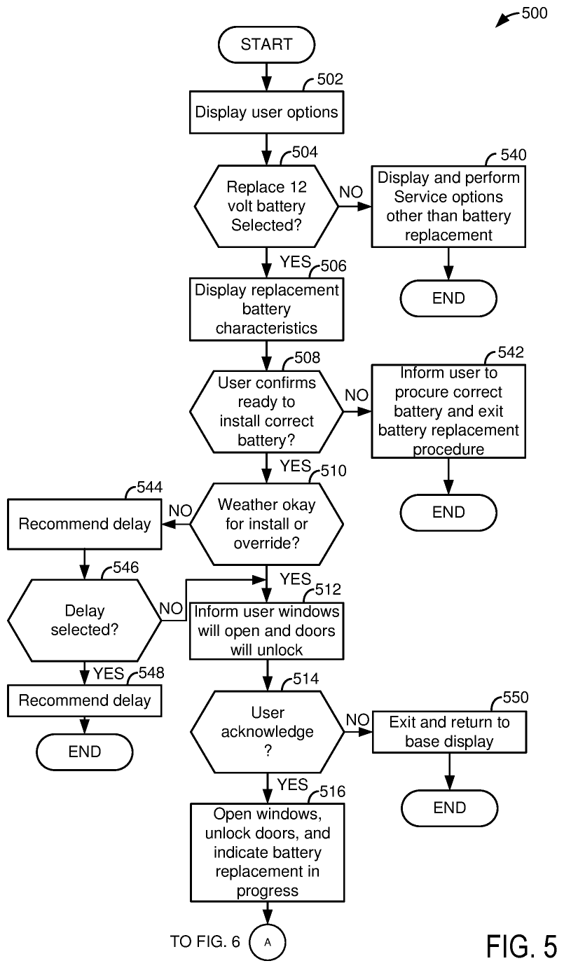

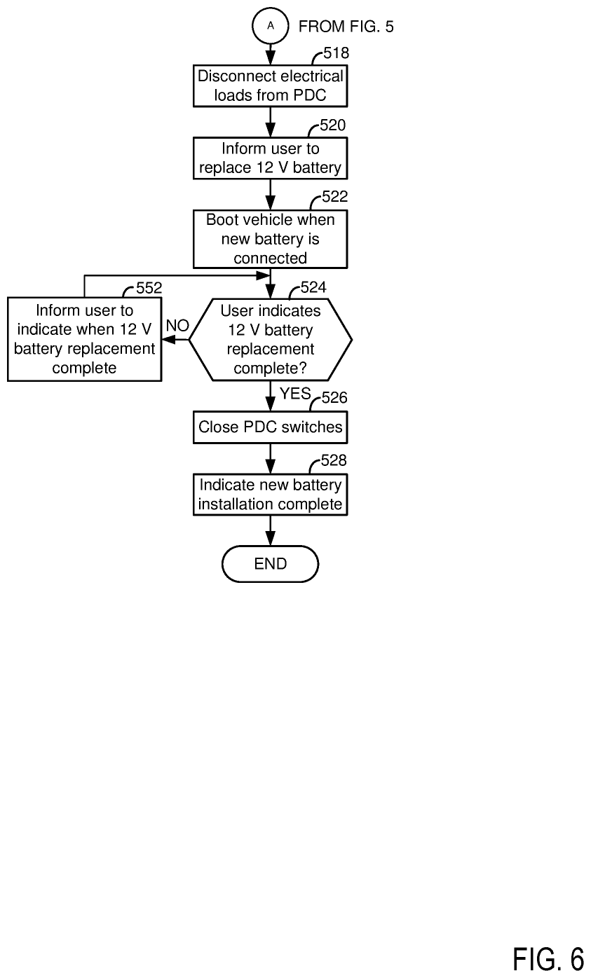

The present description is related to operating an electric power distribution system that includes a lower voltage battery and a higher voltage battery. The lower voltage battery and the higher voltage battery may be included in an electric vehicle as shown in FIG. 1. An infotainment system as shown in FIG. 2 may provide interactive step-by-step instruction for replacing a lower voltage battery. In particular, the infotainment system may display selections and receive input from a display as shown in FIG. 3. The power distribution system may include a power distribution system as shown in FIG. 4. A method for replacing a low voltage battery is shown in FIGS. 5 and 6.

Manufacturers may include an owner's manual for minor maintenance instructions for a vehicle and owner's may search for on-line videos that give step-by-step instructions for vehicle maintenance. Either reference source may be used when replacing a lower voltage (e.g., 12 volt) battery of a vehicle. However, on-line videos may not follow a manufacturer's recommended procedure to replace the lower voltage battery and it may take effort to read through a paper version of an owner's manual. Further, on-line videos and owner's manuals have no knowledge of system operating conditions during battery replacement. Therefore, these two approaches may exhibit short comings that may make low voltage battery replacement more difficult than may be desired for some users.

The inventors herein have recognized the above-mentioned issues and have developed a vehicle power system, comprising: a human/machine interface; a power distribution system including a plurality of switches, each of the plurality of switches in electric communication with an electric power consumer, the human/machine interface in electrical communication with the power distribution system; and one or more controllers including executable instructions for an interactive application for servicing a battery that causes the one or more controllers to display vehicle power system status and receive input that indicates vehicle power system status via a human user.

By providing an power distribution system that includes an interactive application for servicing a battery, it may be possible to provide the technical result of simplifying installation of a lower voltage battery. Further, since the approach is incorporated into the vehicle, users may be assured that the approach follows the vehicle manufacturer's procedures and that it is easily accessible. In addition, status of the power distribution system may be provided to a user to increase communication between the user and the power distribution system so that the user's confidence level to perform routine maintenance may be increased.

The present description may provide several advantages. In particular, the approach may simplify lower voltage battery replacement. Further, the approach may control vehicle systems during lower voltage battery replacement in a way that reduces a possibility disconnecting the lower voltage battery when a large amount of power is being drawn from the lower voltage battery. In addition, the approach provides for an orderly electrical system shutdown so that a possibility of electrical system errors may be reduced.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of a vehicle 121 including a powertrain or driveline 100. A front portion of vehicle 121 is indicated at 110 and a rear portion of vehicle 121 is indicated at 111. Driveline 100 includes electric machine 126. Electric machine 126 may consume or generate electrical power depending on its operating mode. Throughout the description of FIG. 1, mechanical connections between various components are illustrated as solid lines, whereas electrical connections between various components are illustrated as dashed lines.

Driveline 100 has a rear axle 122. In some examples, rear axle 122 may comprise two half shafts, for example first half shaft 122a, and second half shaft 122b. Driveline 100 also includes front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 1260 of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over network 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electric energy storage device 132. Furthermore, electric machine 126 may provide a generator function to convert the vehicle's kinetic energy into electrical energy, where the electrical energy may be stored at electric energy storage device 132 for later use by electric machine 126. An inverter 134 may convert alternating current generated by electric machine 126 to direct current for storage at the electric energy storage device 132 and vice versa. Electric drive system 135 includes electric machine 126 and inverter 134. Electric energy storage device 132 may be a traction battery (e.g., a battery that supplies power to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with vehicle slowing pedal 156.

Electric energy storage device 132 may periodically receive electrical energy from a power source such as a stationary power grid (not shown) residing external to the vehicle (e.g., not part of the vehicle). As a non-limiting example, driveline 100 may be configured as a plug-in electric vehicle (EV), whereby electrical energy may be supplied to electric energy storage device 132 via the power grid (not shown).

Electric energy storage device 132 includes an electric energy storage device controller 139. Electric energy storage device controller 139 may provide charge balancing between energy storage element (e.g., battery cells) and communication with other vehicle controllers (e.g., controller 112). Electric energy storage device 132 is electrically coupled to a first direct current (DC)/DC converter 137 (e.g., higher capacity DC/DC converter) and a second DC/DC converter 153. The first DC/DC converter 137 and the second DC/DC converter 153 may be bi-directional. The first DC/DC converter 137 and the second DC/DC converter 153 (e.g., a DC/DC converter with lower capacity than first DC/DC converter 137) are electrically coupled to power distribution module 138. A lower voltage battery 155 (e.g., a 12-volt battery) is also electrically coupled to power distribution module 138.

One or more wheel speed sensors (WSS) 195 may be coupled to one or more wheels of driveline 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Infotainment system 140 (e.g., a human/machine interface) may receive input data from human 102 and may display messages and data to human 102. Infotainment system 140 may communicate to controller 112 and power distribution module 138 via network 199 (e.g., a controller area network (CAN) or an Ethernet network).

Referring now to FIG. 2, a view of an example infotainment system 140 is shown. Infotainment system 140 may include a display 202, and display 202 may present messages and data to human 102. Additionally, infotainment system 140 may receive input from human 102 via display 202 (e.g., a touch display) or a key pad or dials (not shown). Infotainment system 140 is shown in passenger cabin 210 of vehicle 121 and it may operate as a human/machine interface.

Infotainment system 140 includes a controller 273, memory 272 (e.g., read exclusive memory, random access memory, keep alive memory, etc.), and inputs and outputs 271 (e.g., analog to digital converters, digital inputs and outputs).

Turning now to FIG. 3, an example view screen 302 posted to display 202 of infotainment system 140 is shown. In this example, the view screen 302 indicates that part of the battery replacement procedure will be to automatically open vehicle door locks and windows. The view screen 302 solicits input from a user and the user may cause the vehicle door locks and/or windows to open when a user supplies input to display 202 at location 304. The view screen 302 may also indicate which windows 306 and door locks 308 will be opened. The infotainment system may include a plurality of different screens that guide the user through the battery replacement procedure.

Moving on to FIG. 4, a detailed schematic view of an example electric power distribution system 400 including a power distribution module 138. Electrical connections between the various components shown in FIG. 4 are shown as dashed lines.

Electric power distribution module 138 includes a plurality of switches 450-466 for selectively electrically isolating electric power consumers and electric sources from low voltage bus 410. Lower voltage battery 155 may be selectively coupled to low voltage bus 410 via switch 450. Switch 450 is shown in a closed state that allows electric current flow through the switch. Electric power steering system 402 may be selectively electrically coupled to low voltage bus 410 via switch 452. Switch 452 is shown in an open state. Ultra-capacitor 404 may be selectively electrically coupled to low voltage bus 410 via switch 454. Switch 454 is shown in an open state. Electric vehicle slowing actuators 406 may be selectively electrically coupled to low voltage bus 410 via switch 456. Switch 456 is shown in an open state. Infotainment system 140 may be selectively electrically coupled to low voltage bus 410 via switch 458. Switch 458 is shown in an open state. First DC/DC converter 137 may be selectively electrically coupled to low voltage bus 410 via switch 460. Switch 460 is shown in an open state. Second DC/DC converter 153 may be selectively electrically coupled to low voltage bus 410 via switch 462. Switch 462 is shown in an open state. Vehicle lights 412 may be selectively electrically coupled to low voltage bus 410 via switch 464. Switch 464 is shown in an open state. Climate control system 414 may be selectively electrically coupled to low voltage bus 410 via switch 466. Switch 466 is shown in an open state.

Power distribution module 138 includes a controller 470 for sensing a voltage of low voltage bus 410 and selectively opening and closing switches 450-466. Controller 470 includes a processor 473, memory 472 (e.g., read exclusive memory, random access memory, keep alive memory, etc.), and inputs and outputs 471 (e.g., analog to digital converters, digital inputs and outputs).

Thus, the system of FIGS. 1, 2, and 4 provides for a vehicle power system, comprising: a human/machine interface; a power distribution system including a plurality of switches, each of the plurality of switches in electric communication with an electric power consumer, the human/machine interface in electrical communication with the power distribution system; and one or more controllers including executable instructions for an interactive application for servicing a battery that causes the one or more controllers to display vehicle power system status and receive input that indicates vehicle power system status via a human user. In a first example, the vehicle power system includes where the plurality of switches are comprised of transistors. In a second example that may include the first example, the vehicle power system further comprises additional executable instructions that cause the one or more controllers to open one or more of the plurality of switches in response to a request to replace a battery. In a third example that may include one or both of the first and second examples, the vehicle power system further comprises additional executable instructions that cause the one or more controllers to communicate attributes of a replacement battery via the human/machine interface. In a fourth example that may include one or more of the first through third examples, the vehicle power system further comprises additional executable instructions that cause the one or more controllers to communicate a request for permission to perform an action via the human/machine interface, the action being to open one or more windows and unlock one or more vehicle doors. In a fifth example that may include one or more of the first through fourth examples, the vehicle power system further comprises additional executable instructions that cause the one or more controllers to open one or more windows and unlock one or more vehicle doors in response to permission to open the one or more widows and unlock the one or more vehicle doors. In a sixth example that may include one or more of the first through fifth examples, the vehicle power system further comprises additional executable instructions that cause the one or more controllers to confirm environmental conditions are acceptable before opening the one or more windows and unlocking the one or more vehicle doors.

In addition, the system of FIGS. 1, 2, and 4 provides for a vehicle power system, comprising: a power distribution system including a plurality of switches and a controller that senses a voltage of a power distribution bus and that includes executable instructions stored in non-transitory memory that cause the controller to close one or more switches in response to a replacement battery being electrically coupled to the power distribution system and a variable stored in memory that indicates a battery replacement procedure is in progress. In a first example, the vehicle power system further comprises additional executable instructions that cause the controller to open the one or more switches in response to user input indicating that one or more vehicle widows is not fully closed. In a second example that may include the first example, the vehicle power system further comprises additional executable instructions that cause the controller to open the one or more switches in response to user input indicating that one or more vehicle doors is unlocked. In a third example that may include one or both of the first and second examples, the vehicle power system includes where the one or more switches selectively couple the power distribution system to a first DC/DC converter. In a fourth example that may include one or more of the first through fourth examples, the vehicle power system includes where the one or more switches selectively couple the power distribution system to a second DC/DC converter.

Referring now to FIGS. 5 and 6, a method for replacing a lower voltage battery of a vehicle is shown. At least portions of method of FIGS. 5 and 6 may be included as executable instructions stored in non-transitory memory of the system of FIGS. 1, 2, and 4. The method of FIGS. 5 and 6 may reside in a single controller, or alternatively, in two or more controllers (e.g., infotainment controller 273 and power distribution module controller 473). In addition, the methods of FIGS. 5 and 6 may work in cooperation with the system of FIGS. 1, 2, and 4 to facilitate changing of a lower voltage battery.

At 502, method 500 displays vehicle options for a user (e.g., human passenger) to select. The vehicle options may be displayed via a human/machine interface. Method 500 proceeds to 504.

At 504, method 500 judges whether or not a selection to replace a vehicle's lower voltage battery has been selected. If so, the answer is yes and method 500 proceeds to 506. Otherwise, the answer is no and method 500 proceeds to 540.

At 540, method 500 displays and performs service options and vehicle options other than the low voltage battery replacement procedure. Method 500 proceeds to exit.

At 506, method 500 displays characteristics for an acceptable replacement lower voltage battery. The characteristics may include but are not limited to voltage and ampere hour rating. Method 500 proceeds to 508.

At 508, method 500 waits for the user to confirm that they have the appropriate lower voltage battery and that they are ready to continue the lower voltage battery replacement process. If the user confirms that they have the appropriate lower voltage battery and are ready to continue the battery installation process, the answer is yes and method 500 proceeds to 510. Otherwise, the answer is no and method 500 proceeds to 542.

At 542, method 500 informs the user to procure the correct battery and method 500 exits the battery replacement procedure.

At 510, method 500 notifies the user that the vehicle's windows will be automatically opened and requests that the user indicate that weather conditions surrounding the vehicle that is receiving the replacement battery do not include heavy amounts of raining and/or snow. The notification is provided so that an excess amount of water may not enter the passenger cabin when the widows are automatically opened during the battery replacement procedure. If the user indicates that the weather is appropriate for lower voltage battery replacement, the answer is yes and method 500 proceeds to 512. Otherwise, the answer is no and method 500 proceeds to 544.

At 544, method 500 recommends delaying the lower voltage battery replacement procedure and prompts the user to select delaying the procedure or continuing the procedure. Method 500 proceeds to 546.

At 546, method 500 judges whether or not delaying the lower voltage battery replacement has been selected. If so, the answer is yes and method 500 proceeds to 548. Otherwise, the answer is no and method 500 proceeds to 512.

At 548, method 500 returns the user display to a base screen and exits.

At 512, method 500 informs the user that one or more of the vehicle's windows will be at least partially automatically opened and that vehicle door locks will be automatically turned off to allow the user to exit and enter the vehicle when the lower voltage battery is being replaced and a power source to open the vehicle door locks and windows is not available. Method 500 proceeds to 514.

At 514, method 500 waits to confirm that the user and the vehicle is ready for one or more windows to be at least partially opened and for vehicle door locks to be opened. If the user acknowledges that permission is given to at least partially open a vehicle window and door locks, the answer is yes and method 500 proceeds to 516. Otherwise, the answer is no and method 500 proceeds to 550.

At 550, method 500 exits the battery replacement procedure and the display reverts to a baseline display page. Method 500 proceeds to exit.

At 516, method 500 at least partially opens at least one vehicle window and unlocks vehicle doors. Opening the vehicle windows and door locks may give users access to the vehicle's interior when the low voltage battery is removed from the vehicle. Since the vehicle's windows and door locks move by power that may be supplied by the low voltage battery, lowering the windows and unlocking the doors puts windows and doors in a state that may be desired by the user. The user display screen may be updated to reflect that the battery replacement process is in progress. Method 500 also sets a value of a variable in controller memory to a value that indicates that low voltage battery replacement is in progress. The value may be retained when power is remove from the power distribution system. Method 500 proceeds to 518.

At 518, method 500 opens one or more switches to reduce the electrical load on the electric power distribution system. In one example, method 500 opens each switch of the electric power distribution system that selectively allows an electric power source or consumer to be coupled to the electric power distribution system and low voltage bus, except for the switch that selectively couples the lower voltage battery (e.g., 155 of FIG. 1) to the electric power distribution system. The switch that selectively couples the lower voltage battery to the electric power distribution system is held closed so that power from the lower voltage battery may flow to the electric power distribution system and the low voltage bus. Thus, at 518 electrical loads such as electric power steering, electrically actuated wheel slowing friction pads, DC/DC converters, vehicle lighting, vehicle infotainment system, ultra-capacitor, and climate control system are electrically decoupled from the low voltage bus and the electric power distribution system. By decoupling these devices, it may be possible to remove the battery without arching between battery terminals and connectors. Method 500 proceeds to 520.

At 520, method 500 informs the user to replace the low voltage battery. The user replaces the low voltage battery and the screen may go blank as power is removed by removing the low voltage battery. Method 500 proceeds to 522.

At 522, method 500 reboots or restarts the controller of the electric power distribution unit when the new or replacement battery is installed to the vehicle. Method 500 may also read the value of the variable that indicates the status of battery replacement being in progress. If the value of the variable indicates that battery replacement is in progress, method 500 displays a message via a human/machine interface that requests that the user confirm that the battery has been replaced. Method 500 proceeds to 524.

At 524, method 500 judge whether or not the user has indicated that the lower voltage battery has been replaced. If so, the answer is yes and method 500 proceeds to 526. Otherwise, the answer is no and method 500 proceeds to 552.

At 552, method 500 requests that the user perform the low voltage battery replacement process via a message to the human/machine interface and method 500 returns to 524.

At 526, method 500 closes the electric power distribution system switches so that the electric power consumers may resume operation and so that the DC/DC converters may be electrically coupled to the low voltage bus. Method 500 proceeds to 528.

At 528, method 500 indicates that low voltage battery placement is finished via the human/machine interface and returns the display of the human/machine interface back to its base screen. Method 500 proceeds to exit.

In this way, method 500 takes automated actions to allow access to the vehicle during low voltage battery replacement. In addition, method 500 automatically removes electric loads from the low voltage bus so that the possibility of arching between low voltage battery terminals and connectors may be reduced. Further, the interactive process is ready accessible and it may provide users with increased confidence when replacing a low voltage battery.

Thus, the method of FIGS. 5 and 6 provides for a method for a replacing a battery of a vehicle, comprising: via one or more controllers, opening a plurality of switches in response to a request to replace the battery; and indicating to commence replacing the battery after opening the plurality of switches. In a first example, the method includes where the indicating is performed via a human/machine interface. In a second example that may include the first example, the method further comprises requesting input to the human/machine interface that indicates that the battery has been replaced. In a third example that may include one or both of the first and second examples, the method further comprise closing the plurality of switches in response to input to the human/machine interface that indicates that the battery has been replaced. In a fourth example that may include one or more of the first through third examples, the method further comprises displaying characteristics of a replacement battery before opening the plurality of switches. In a fifth example that may include one or more of the first through fourth examples, the method includes where the indicating and the displaying characteristics is performed via a human/machine interface of the vehicle. In a sixth example that may include one or more of the first through fifth examples, the method includes where the plurality of switches selectively electrically couples electric power consumers to a power distribution center and the battery. In a seventh example that may include one or more of the first through sixth examples, the method further comprises requesting input to the one or more controllers to confirm that the battery has been replaced.

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, electric and hybrid vehicle configurations could use the present description to advantage.

1. A vehicle power system, comprising:
a human/machine interface;
a power distribution system including a plurality of switches, each of the plurality of switches in electric communication with an electric power consumer, the human/machine interface in electrical communication with the power distribution system; and
one or more controllers including executable instructions for an interactive application for servicing a battery that causes the one or more controllers to display vehicle power system status and receive input that indicates vehicle power system status via a human user.

2. The vehicle power system of claim 1, where the plurality of switches are comprised of transistors.

3. The vehicle power system of claim 2, further comprising additional executable instructions that cause the one or more controllers to open one or more of the plurality of switches in response to a request to replace the battery.

4. The vehicle power system of claim 3, further comprising additional executable instructions that cause the one or more controllers to communicate attributes of a replacement battery via the human/machine interface.

5. The vehicle power system of claim 4, further comprising additional executable instructions that cause the one or more controllers to communicate a request for permission to perform an action via the human/machine interface, the action being to open one or more windows and unlock one or more vehicle doors.

6. The vehicle power system of claim 5, further comprising additional executable instructions that cause the one or more controllers to open one or more windows and unlock one or more vehicle doors in response to permission to open the one or more windows and unlock the one or more vehicle doors.

7. The vehicle power system of claim 6, further comprising additional executable instructions that cause the one or more controllers to confirm environmental conditions are acceptable before opening the one or more windows and unlocking the one or more vehicle doors.

8. A method for a replacing a battery of a vehicle, comprising:
via one or more controllers, opening a plurality of switches in response to a request to replace the battery; and
indicating to commence replacing the battery after opening the plurality of switches.

9. The method of claim 8, where the indicating is performed via a human/machine interface.

10. The method of claim 9, further comprising requesting input to the human/machine interface that indicates that the battery has been replaced.

11. The method of claim 10, further comprising closing the plurality of switches in response to input to the human/machine interface that indicates that the battery has been replaced.

12. The method of claim 8, further comprising displaying characteristics of a replacement battery before opening the plurality of switches.

13. The method of claim 12, where the indicating and the displaying characteristics is performed via a human/machine interface of the vehicle.

14. The method of claim 8, where the plurality of switches selectively electrically couples electric power consumers to a power distribution center and the battery.

15. The method of claim 8, further comprising requesting input to the one or more controllers to confirm that the battery has been replaced.

16. A vehicle power system, comprising:
a power distribution system including a plurality of switches and a controller that senses a voltage of a power distribution bus and that includes executable instructions stored in non-transitory memory that cause the controller to close one or more switches in response to a replacement battery being electrically coupled to the power distribution system and a variable stored in memory that indicates a battery replacement procedure is in progress.

17. The vehicle power system of claim 16, further comprising additional executable instructions that cause the controller to open the one or more switches in response to user input indicating that one or more vehicle widows is not fully closed.

18. The vehicle power system of claim 16, further comprising additional executable instructions that cause the controller to open the one or more switches in response to user input indicating that one or more vehicle doors is unlocked.

19. The vehicle power system of claim 16, where the one or more switches selectively couple the power distribution system to a first DC/DC converter.

20. The vehicle power system of claim 19, where the one or more switches selectively couple the power distribution system to a second DC/DC converter.
